(19) United States
(12) Patent Application Publication
(10) Pub. No.: US 2007/0196767 A1
(43) Pub. Date: Aug. 23, 2007

(54) Use Of Squaric Acid Dyes In Optical Layers For Optical Data Recording

(75) Inventor: Andre Weiss, Franfurt am Main (DE)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT INTERNATIONAL LTD, Muttenz (CH)

(21) Appl. No.: 11/628,530

(22) PCT Filed: May 23, 2005
(86) PCT No.: PCT/IB05/01694

§ 371 Date: Dec. 1, 2006

(30) Foreign Application Priority Data
Jun. 3, 2004 (EP) 04013144.3

(51) Int. Cl. G11B 7/24

(52) U.S. Cl. 430/270.18; 430/945; 428/64.8; 369/284

(57) ABSTRACT

The present invention relates the use of squaric acid dyes in optical layers for optical data recording, preferably for optical data recording using a laser with a wavelength up to 450 nm. The invention further relates to a write only read many (WORM) type optical data recording medium capable of recording and reproducing information with radiation of blue laser, which employs a squaric acid based dye in the optical layer.

The present invention relates to the use of squaric acid dyes in optical layers for optical data recording, preferably for optical data recording using a laser with a wavelength up to 450 nm.

The invention further relates to a write once read many (WORM) type optical recording medium capable of recording and reproducing information with radiation of blue laser, which employs a squaric acid dye in the optical layer.

Recently, organic dyes have attracted considerable attention in the field of diode-laser optical storage. Commercial recordable compact discs (CD-R) and recordable digital versatile discs (DVD-R) can contain, as recording layer, numerous dyes based on phthalocyanine, hemicyanine, cyanine and metallized azo structures. These dyes are suitable in their respective fields with the laser wavelength criteria. Other general requirements for dye media are strong absorption, high reflectance, high recording sensitivity, low thermal conductivity as well as light and thermal stabilities, durability for storage or non-toxicity.

For industrial application, these dyes have to be suitable for the spin coating process to prepare thin films, i.e. they have to be sufficiently soluble in the organic solvents generally applied in the spin coating process.

WORM (write once read many) type and erasable type optical recording media reproduce information by detecting variations in the reflectivity caused by physical deformation, by alterations of optical characteristics as well as by phase and magnetic properties of a recording layer before and after the recording.

Recordable compact discs (CD-R) are widely known as a WORM type optical recording medium. Recently, digital versatile discs (DVD) with increased information storage capabilities up to 4.7 GBytes have been commercialized.

The DVD-R technology adopts as a light source a red diode laser with a wavelength of 630-670 nm. Thereby the pit size and track interval can be reduced, increasing the information storage capacity by up to 6-8 times compared to CD-R's. Blu-ray® discs (Blu-ray® disc is a standard developed by Hitachi Ltd., LG Electronics Inc., Matsushita Electric Industrial Co. Ltd., Pioneer Corporation, Royal Philips Electronics, Samsung Electronics Co. Ltd., Sharp Corporation, Sony Corporation, Thomson Multimedia) are going to be the next milestone in optical recording technology. Its new specification increases the data storage up to 27 GBytes per recording layer for a 12 cm diameter disc. By adopting a blue diode laser with a wavelength of 405 nm (GaN or SHG laser diodes), the pit size and track interval can be further reduced, again increasing the storage capacity by an order of magnitude.

The construction of optical data recording media is known in the art. An optical data recording media generally comprises a substrate and a recording layer, the optical layer. Usually discs or wavers of organic polymeric materials are used as substrates. Preferred substrates are polycarbonate (PC) or polymethylmethacrylate (PMMA). The substrate has to provide an even and uniform surface of high optical quality. The optical layer is deposited thereon in a thin and uniform film of high optical quality and defined thickness. Finally, a reflective layer, e.g. aluminium, gold or copper, is deposited upon the optical layer.

Advanced optical data recording media may comprise further layers, such as protective layers, adhesive layers or additional optical layers.

To provide for a thin and uniform film of the optical layer, the material is usually deposited by spin coating, vacuum evaporation, jet coating, rolling coating or soaking. The preferred process in industry is spin coating to form an optical layer of about 70 nm to 250 nm thickness. For the application in the spin coating process, the material of the optical layer has to be highly soluble in organic solvents.

WO03/079339A1 (Bayer AG) discloses squarylium dyes as a light absorbing compound in the information layer of optical data carriers. In particular, WO03/079339A1 discloses disubstituted squarylium compounds of the following general structure useful for optical recording in DVD-R discs, working with red laser light (635-660 nm):

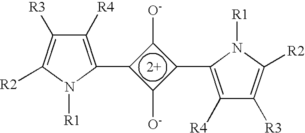

JP 2001322356 (Ricoh KK) discloses disubstituted squarylium compounds in a mixture with at least one kind of azo metal chelate compound for optical recording with a wavelength from 600 to 720 nm.

JP 06184109 (Mitsubishi Chem. Ind.) discloses disubstituted squarylium compounds of the following general formulae which are useful as coloring materials for polymers, as bicolor dyes for liquid crystals, and as photosensitive materials for electrophotographic printers, as recording materials for optical discs, as nonlinear optical materials, and as materials for near IR-cut filters in the fields of semiconductor laser application:

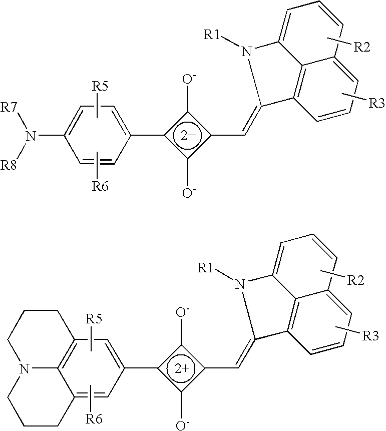

JP 06184134 (Mitsubishi Chem. Ind.) discloses disubstituted squarylium compounds of the following general formulae useful in the field of dyes, polymer coloring materials, dichroic pigments for liquid crystals, and photosensitive materials for electrophotography such as electrophotographic printers, as recording material for optical disk, and for semiconductor laser applications such as near-infrared cut filter material:

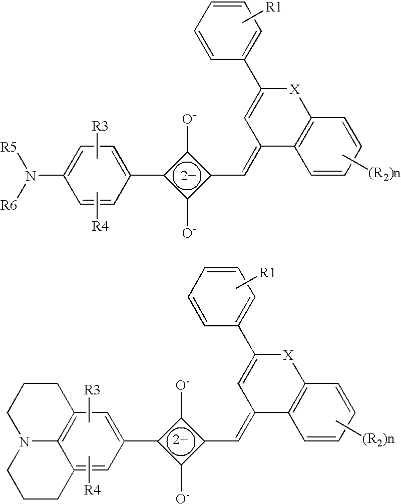

DE 4040906 (BASF AG) discloses asymmetric azulene squaric acid dyes of the following general formula and an optical recording medium comprising said dyes. The laser wavelength used for recording is 750-900 nm.

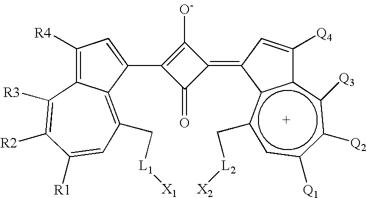

EP 1152001 B1 (Kyowa Hakko Kogyo Co.) discloses asymmetric squarylium compounds with pyrazole and indoline units of the following general formula, and an optical recording medium comprising said squarylium compound. The squarylium compounds have an maximum absorption wavelength of 550-600 nm.

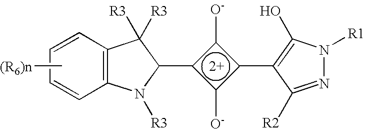

EP 1334998 A1 (Kyowa Hakko Kogyo Co.) discloses asymmetric squarylium metal complexes with pyrazole and indoline units of the following general formula, and optical recording medium comprising said squarylium complex. The squarylium compounds have an maximum absorption wavelength of 550-600 nm.

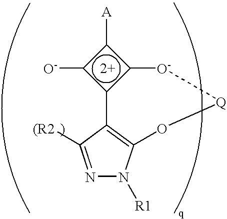

Matsui et al. (Dyes and Pigments 58, 2003, 219-226) discloses 3-Aryl-4-hydroxycyclobut-3-ene-1,2-dione, i.e. a monosubstituted squarylium compound, as sensitizers for TiO₂ solar cell.

DE 1 670 364 (Chemische Werke Hüls AG) of 1966 discloses 1-phenyl-2,3-dialkyl-4-[2′-hydroxy-3′,4′-dioxo-cyclo-butene-(1′)-yl]-pyrazol-5-one, i.e. a monosubstituted squarylium compound, and a process for its preparation.

U.S. Pat. No. 5,106,997 (Fuji Xerox Co.) discloses squarylium derivatives of the general formula

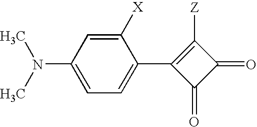

wherein X and Z are defined as in the specification, for the use in nonlinear optical elements.

Surprisingly it now has been found, that monosubstituted squaric acid derivatives as described below are useful as dye compounds in optical layers for optical data recording.

The present invention therefore relates to an optical layer for optical data recording comprising monosubstituted squaric acid compounds as described below and to the use of said optical layers for optical data recording media.

More particularly, the invention relates to a write once read many (WORM) type optical data recording medium capable of recording and reproducing information with radiation of blue laser of preferably 405 nm, which employ a monosubstituted squaric acid dye in the optical layer.

The present invention is directed to an optical layer for optical data recording comprising at least one dye compound of formula (I). 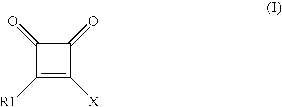
wherein
X represents hydroxy (—OH) or thiol (—SH);
   OR₂ or SR₂ with R₂ being selected from phenyl, benzyl or C₁₋₁₂ alkyl, which are unsubstituted or substituted by hydroxy (—OH), C₆₋₁₂ aryl, halogen, —NR′R″, with R′ and R″ independently being hydrogen, C₁₋₁₂ alkyl or C₆₋₁₂ aryl;
   O⁻ or S⁻ with an cationic counter-ion selected from inorganic cations such as alkaline or earth alkaline cations, or from organic cations such as pyridinium or chinolinium or isochinolinium or ammonium (—NR₅R₆R₇R₈⁺) with R₅ to R₈ independently being selected from hydrogen, C₁₋₁₂ alkyl or C₆₋₁₂ aryl;
   —NR₃R₄, with R₃ and R₄ independently being hydrogen, C₁₋₁₂ alkyl benzyl or C₆₋₁₂ aryl;
R₁ represents one of the moieties (1) to (5) 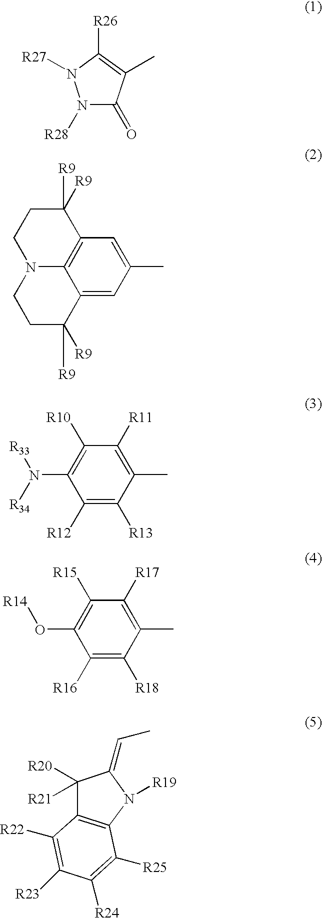
wherein
R₃₃ and R₃₄ independently of one another, represent hydrogen, C₁₋₁₂ alkyl, benzyl or C₆₋₁₂ aryl, or NR₃₃R₃₄ represents pyrrolidyl, piperidyl or morpholyl;
R₉ to R₁₃, R₁₅ to R₁₈, and
R₂₂ to R₂₆ independently of one another, represent hydrogen, C₁₋₁₂ alkoxy, C₁₋₁₂ alkyl (being unsubstituted or substituted by hydroxy (—OH), C₆₋₁₂ aryl, halogen, —NR′R″, in which R′ and R″ are independently hydrogen, C₁₋₁₂ alkyl or C₆₋₁₂ aryl), hydroxy (—OH), halogen, CX₃ with X being chlorine or fluorine; nitro (—NO₂), cyano (CN), C₆₋₁₂ aryl or —NR′R″, in which R′ and R″ are independently hydrogen, C₁₋₁₂ alkyl or C₆₋₁₂ aryl;
R₁₄ and
R₁₉ to R₂₁ independently of one another, represent hydrogen or C₁₋₁₂ alkyl;
R₂₇ to R₂₈ independently of one another, represent hydrogen, benzyl, C₆₋₁₂ aryl or C₁₋₁₂ alkyl being unsubstituted or substituted by hydroxy, C₆₋₁₂ aryl, halogen or —NR′R″, in which R′ and R″ are independently hydrogen, C₁₋₁₂ alkyl or C₆₋₁₂ aryl.

In a preferred aspect, the present invention is directed to an optical layer for optical data recording comprising at least one dye compound of formulae (I), wherein
X represents hydroxy (—OH),
   OR₂ with R₂ being selected from benzyl or C₁₋₁₂ alkyl, or
   NR₃R₄ with R₃ and R₄ independently being hydrogen or C₁₋₁₂ alkyl;
R₁ represents the moiety (1), wherein
R₂₆ represents hydrogen, C₁₋₁₂ alkoxy, C₁₋₁₂ alkyl, hydroxy (—OH), halogen, CX₃ with X being fluorine; nitro (—NO₂), cyano (CN), C₆₋₁₂ aryl or —NR′R″, in which R′ and R″ are independently hydrogen, C₁₋₁₂ alkyl or C₆₋₁₂ aryl;
R₂₇ and R₂₈ independently of one another, represent hydrogen, benzyl, C₆₋₁₂ aryl or C₁₋₁₂ alkyl.

In a more preferred aspect, the present invention is directed to an optical layer for optical data recording comprising at least one dye compound of formulae (I), wherein
X represents hydroxy (—OH),
R₁ represents the moiety (1), wherein
R₂₆ represents hydrogen or C₁₋₁₂ alkyl;
R₂₇ and R₂₈ independently of one another, represent C₆₋₁₂ aryl or C₁₋₁₂ alkyl.

In a most preferred embodiment, the present invention is directed to an optical layer for optical data recording comprising at least one dye compound of formulae (I), wherein
X represents hydroxy (—OH),
R₁ represents the moiety (1), wherein
R₂₆ and R₂₇ represent methyl,
R₂₈ represents phenyl.

An optical layer for optical data recording according to the invention may also comprise a mixture of two or more, preferably of two dye compounds of formula (I) as defined above.

Further, the invention relates to a method for producing optical layers for optical data recording comprising the following steps
(a) providing a substrate
(b) dissolving a dye compound of formula (I) in an organic solvent to form a solution,
(c) coating the solution (b) on the substrate (a);
(d) evaporating the solvent to form a dye layer (the optical layer).

Preferred substrates are polycarbonate (PC) or polymethylmethacrylate (PMMA).

Organic solvents are selected from C₁₋₈ alcohol, halogen substituted C₁₋₈ alcohols, C₁₋₈ ketone, C₁₋₈ ether, halogen substituted C₁₋₄ alkane, or amides.

Preferred C₁₋₈ alcohols or halogen substituted C₁₋₈ alcohols are for example methanol, ethanol, isopropanol, diacetone alcohol (DAA), 2,2,3,3-tetrafluoropropanol, trichloroethanol, 2-chloroethanol, octafluoropentanol or hexafluorobutanol.

Preferred C₁₋₈ ketones are for example acetone, methylisobutylketone, methylethylketone, or 3-hydroxy-3-methyl-2-butanone.

Preferred halogen substituted C₁₋₄ alkanes are for example chloroform, dichloromethane or 1-chlorobutane.

Preferred amides are for example dimethylformamide or dimethylacetamide.

The optical layer (dye layer) obtained preferably has a thickness from 70 to 250 nm.

In a preferred aspect, the present invention provides for an optical layer for optical data recording suitable for high-density recording material, e.g. of the WORM disc format, in a laser wavelength range of from 350-450 nm, preferably around 405 nm.

The dye compounds of formula (I) possess the required optical characteristics (such as high absortivity, high recording sensitivity as examples), an excellent solubility in organic solvents, an excellent light stability and a decomposition temperature of 200-350° C.

Preparation of High Density Optical Data Recording Medium

The preparation of a high density optical data recording medium/a high density optical disc conventionally comprises the following steps:
(a) providing a first substrate
(b) dissolving the dye in an organic solvent to form a solution,
(c) coating the first solution on the first substrate;
(d) drying the solution to form a dye layer and
(e) disposing a reflection layer on the dye layer and
(f) disposing a second substrate on the reflection layer

In step (f), preferably a second substrate is bonded with the first substrate to form the high-density optical disc recording medium. Conventional techniques for bonding are printing, glueing or melting.

### Preparation of Squaric Acid Dyes According to the Invention

The squaric acid dye compounds of formula (I) (in particular those with R₁ being moieties (2) to (5)) are obtained by condensation of the reaction compounds (B-1), (B-2), (B-3) (B-4) or (B-5) with compound (A) in an organic solvent, in a ratio of 1:1, possibly with an acidic or basic auxiliary.

A hydrolysis step may follow in a protonic polar solvent if X or Y do not represent hydroxy.

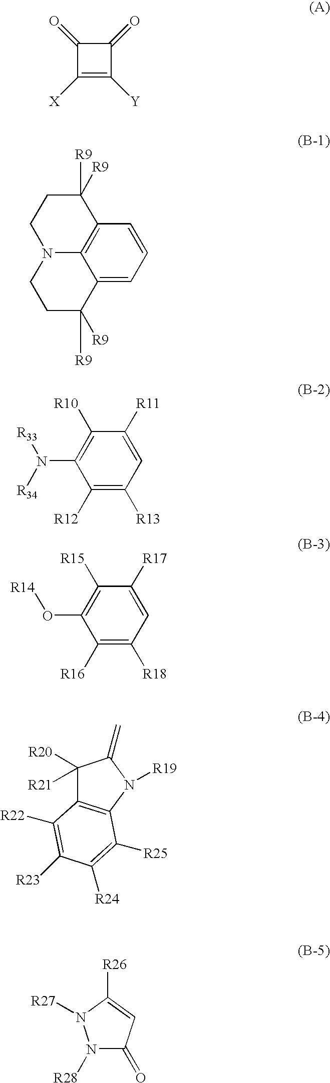

wherein X and Y independently from each other are hydroxy, chlorine, bromine, methoxy, ethoxy, 1-propoxy, 2-propoxy, 1-butoxy, 2-butoxy, and R₃₃, R₃₄, and R₉ to R₂₈ are defined as above.

### EXAMPLES

### Example 1

30 parts of 1 phenyl-2,3-dimethylpyrazol-5-one and 18 parts of 3,4-dihydroxy-3-cyclobutene-1,2-dione are refluxed with a Dean-Stark trap 16 hours in a mixture of 400 parts butanol and 150 parts toluene. The product is filtered and washed with butanol.

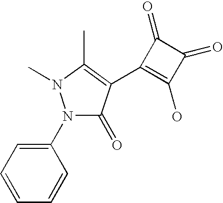

Yield: 67%; Decomp. point (TGA): 259° C.; UV-Vis (EtOH) λₘₐₓ: 343 nm; ε (λₘₐₓ): 24700 1.mol⁻¹.cm⁻¹; MS (positive mode): 285 (M+1)

### Example 2

a) 200 parts of 3,4-dihydroxy-3-cyclobutene-1,2-dione are stirred with 455 parts of thionylchloride and 7 parts of dimethylformamide at 75° C. for 8 hours. The crude product is recrystallized from hexane and dried to give 182 parts of 3,4-dichloro-cyclobut-3-ene-1,2-dione.
b) 9.8 parts of N,N-diethylaniline in 80 parts of dichloromethane are added dropwise to a solution of 10 parts of previously obtained compound in 160 parts of dichloromethane and stirred for 4 hours at room temperature. The solvent is removed by destination and the residue refluxed for 4 hours in a mixture of 160 parts of acetic acid and 40 parts of water. 150 parts of the solvent are destined off and the remaining solution is neutralized by addition of aqueous sodium hydroxide. The reaction mixture is filtered and the presscake recrystallized from acetone to give 6 parts of 3-(4-diethylaminophenyl)-4-hydroxy-cyclobut-3-ene-1,2-dione.

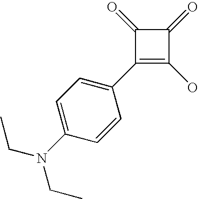

Yield: 39%; Decomp. point (TGA) 326° C.; UV-Vis (DMSO) λₘₐₓ: 381 nm; ε (λₘₐₓ): 39000; MS (positive mode): 246 (M+1)

### Example 3

This dye is synthesized according to the procedure described in example 2, however with N-benzyl-N-ethyl-aniline instead of N,N-diethylaniline.

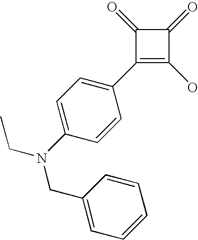

Yield: 30%; Decomp. point (TGA): 199° C.; UV-Vis (CHCl₃) λₘₐₓ: 401 nm; ε (λₘₐₓ): 42000 1.mol⁻¹.cm⁻¹; MS (positive mode): 308 (M+1)

### Example 4

This dye is synthesized according to the procedure described in example 2, however N,N-diphenylmethylamine instead of N,N-diethylaniline is used.

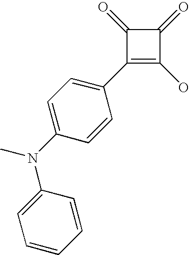

Yield: 57%; Decomp. point (TGA): 238° C.; UV-Vis (DMSO) λₘₐₓ: 387 nm; ε (λₘₐₓ): 19900 1·mol⁻¹·cm⁻¹; MS (positive mode): 280(M+1)

### Example 5

A mixture of 36 parts of 3,4-dichloro-cyclobut-3-ene-1,2-dione and 49 parts 2,6-di(tert-butyl)phenol in 650 parts of dichloromethane is added dropwise to 32 parts of aluminum(III)chloride in 650 parts of dichloromethane. The mixture is stirred for 2 hours at reflux temperature. Excess aluminum(III)chloride is hydrolyzed with 500 parts of ice. The organic layer is separated and evaporated and the resulting residue is refluxed in 600 parts of acetic acid and 200 parts of water for 4 hours. Afterwards, the solution is neutralized by addition of aqueus sodium hydroxyde and the product filtered and dried.

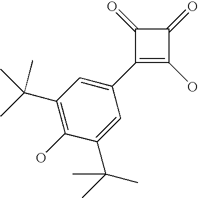

Yield: 25%; Decomp. point (TGA): 318° C.; UV-Vis (H₂O) λₘₐₓ: 340 nm; ε (λₘₐₓ) 25600 1·mol⁻¹·cm⁻¹; MS (positive mode): 303 (M+1)

### Example 6

a) 10 parts of 3,4-dihydroxy-3-cyclobutene-1,2-dione are refluxed in 250 parts of ethanol. After 3 hours, the solvent is removed by destination and substituted by a fresh portion of ethanol and refluxed for one hour. This procedure is repeated two more times. After destining the solvent, the residue is extracted with hexane. From the hexane phase, 6 parts of 3,4-diethoxy-3-cyclobutene-1,2-dione are obtained by evaporation.
b) To a solution of 58 parts of 2-methylene-1,3,3-trimethylindoline in 500 parts of ethanol are added 33 parts of triethylamine and 55 parts of previously obtained compound in 600 parts of ethanol. After stirring for 2 hours at room temperature, the solvent is destined off and the residue refluxed for 5 minutes in 500 parts of ethanol containing 40 parts of aqueous saturated sodium hydroxyde solution. The mixture is neutralized with diluted hydrochloric acid and evaporated until the product precipitates. The product is filtered and dried.

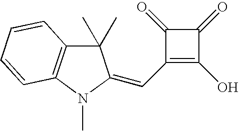

Yield: 56%; Decomp. point (TGA): 286° C.; UV-Vis (EtOH) λₘₐₓ: 418 nm; ε (λₘₐₓ): 18600 1·mol⁻¹·cm⁻¹; MS (positive mode): 270 (M+1)

### Example 7

This dye is synthesized according to the procedure described in example 1, however with N-(3-methoxyphenyl)-N-dimethylamine instead of N,N-diethylaniline.

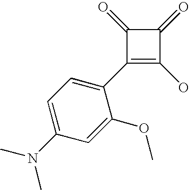

Yield: 43%; Decomp. point (TGA): 243° C.; UV-Vis (CH₂Cl₂) λₘₐₓ: 396 nm; ε (λₘₐₓ): 38600 1.mol⁻¹.cm⁻¹; MS (positive mode): 248 (M+1)

### Example 8

This dye is synthesized according to the procedure described in example 1, however with N-Phenylmorpholine instead of N,N-diethylaniline.

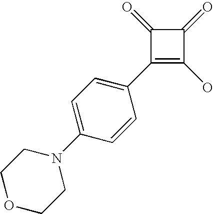

Yield: 18%; Decomp. point (TGA): 254° C.; UV-Vis (CH₂Cl₂) λₘₐₓ: 372 nm; ε (λₘₐₓ): 38100 1.mol⁻¹.cm⁻¹; MS (positive mode): 260 (M+1)

### Application Example

The optical and thermal properties of the monosubstituted squaric acid dye compounds were studied. The dyes show high absorption at the desired wavelengths. In addition, the shape of the absorption spectra, that still remains critical to the disc reflectivity and formation of clean mark edges, are composed of one major band, comprised in a range of from 350 to 500 nm, preferably of from 350 to 400 nm.

More precisely, n values of the refractive index were evaluated between 1.7 and 2.7. Light stabilities were found comparable to commercial dyes which usually are stabilized with quenchers for the use in optical data recording.

Sharp threshold of thermal decomposition in the required temperature range characterizes the new monosubstituted squaric acid dyes which is assumed to be desirable for the application in optical layers for optical data recording.

As a conclusion, the monosubstituted squaric acid dye compounds are within the specifications which are primarily required by the industry for the use of dyes in optical data recording, in particular in the next-generation optical data recording media (Blu-ray® disc) in the blue laser range.

1. An optical layer for optical data recording comprising at least one dye compound of formula(I) 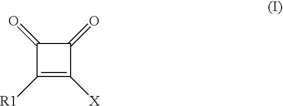
wherein
X represents hydroxy (—OH), thiol (—SH);
OR₂ or SR₂ with R₂ being phenyl, benzyl or C₁₋₁₂ alkyl, unsubstituted or substituted by hydroxy (—OH),
C₆₋₁₂ aryl, halogen, —NR′R″, with R′ and R″ independently being hydrogen, C₁₋₁₂ alkyl or C₆₋₁₂ aryl;
O⁻ or S⁻ with a cationic counter-ion selected from the group consisting of inorganic cations and organic cations;
R₁ represents one of the moieties (1) to (5) 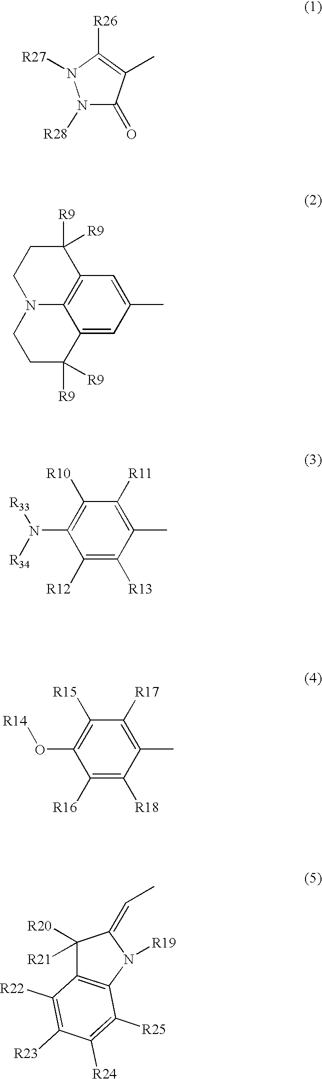
wherein
R₃₃ and R₃₄ independently of one another, are hydrogen, C₁₋₁₂ alkyl, benzyl, C₆₋₁₂ aryl, or NR₃₃R₃₄ represents pyrrolidyl, piperidyl or morpholyl;
R₉ to R₁₃, R₁₅ to R₁₈, and
R₂₂ to R₂₆ independently of one another, are hydrogen, C₁₋₁₂ alkoxy, C₁₋₁₂ alkyl unsubstituted or substituted by hydroxy (—OH), C₆₋₁₂ aryl, halogen, —NR′R″, in which R′ and R″ are independently hydrogen, C₁₋₁₂ alkyl or C₆₋₁₂ aryl, hydroxy (—OH), halogen, CX₃ with X being chlorine or fluorine; nitro (—NO₂), cyano (CN), C₆₋₁₂ aryl or —NR′R″, in which R′ and R″ are independently hydrogen, C₁₋₁₂ alkyl or C₆₋₁₂ aryl;
R₁₄ and
R₁₉ to R₂₁ independently of one another, are hydrogen or C₁₋₁₂ alkyl;
R₂₇ to R₂₈ independently of one another, are hydrogen, benzyl, C₆₋₁₂ aryl or C₁₋₁₂ alkyl unsubstituted or substituted by hydroxy (—OH), C₆₋₁₂ aryl, halogen, —NR′R″, in which R′ and R″ are independently hydrogen, C₁₋₁₂ alkyl or C₆₋₁₂ aryl.

2. An optical layer for optical data recording according to claim 1, wherein
X is hydroxy (—OH),
OR₂ wherein R₂ is benzyl or C₁₋₁₂ alkyl, or
NR₃R₄ with R₃ and R₄ independently being hydrogen or C₁₋₁₂ alkyl;
R₁ is the moiety (1)
wherein
R₂₆ is hydrogen, C₁₋₁₂ alkoxy, C₁₋₁₂ alkyl, hydroxy (—OH), halogen, CX₃ with X being fluorine; nitro (—NO₂), cyano (CN), C₆₋₁₂ aryl or —NR′R″ , in which R′ and R″ are independently hydrogen, C₁₋₁₂ alkyl or C₆₋₁₂ aryl;
R₂₇ and R₂₈ independently of one another, are hydrogen, benzyl, C₆₋₁₂ aryl or C₁₋₁₂ alkyl.

3. An optical layer for optical data recording according to claim 1, wherein
X is hydroxy (—OH),
R₁ is the moiety (1),
wherein
R₂₆ represents hydrogen or C₁₋₁₂ alkyl;
R₂₇ to R₂₈ independently of one another, represent are C₆₋₁₂ aryl or C₁₋₁₂ alkyl.

4. An optical layer for optical data recording according to claim 1, wherein
X is hydroxy (—OH),
R₁ is the moiety (1),
wherein
R₂₆and R₂₇ is methyl,
R₂₈ is phenyl.

5. A method for producing an optical layer for optical data recording according to claim 1, comprising the steps of
(a) providing a substrate
(b) dissolving a dye compound of formula (I) in an organic solvent to form a solution,
(c) coating the solution (b) on the substrate (a);
(d) evaporating the solvent to form the optical layer.

6. A method according to claim 5, wherein the substrate is polycarbonate (PC) or polymethylmethacrylate (PMMA).

7. A method according to claim 5, wherein the organic solvent is selected from the group consisting of C₁₋₈ alcohol, halogen substituted C₁₋₈ alcohols, C₁₋₈ ketone, C₁₋₈ ether, halogen substituted C₁₋₄ alkane, and amides.

8. A method according to claim 7, wherein the C₁₋₈ alcohols or halogen substituted C₁₋₈ alcohols are selected from the group consisting of methanol, ethanol, isopropanol, diacetone alcohol (DAA), 2,2,3,3-tetrafluoropropanol, trichloroethanol, 2-chloroethanol, octafluoropentanol or and hexafluorobutanol; wherein
the C₁₋₈ ketones are selected from the group consisting of acetone, methylisobutylketone, methylethylketone, and 3-hydroxy-3-methyl-2-butanone;
wherein
the halogen substituted C₁₋₄ alkanes are selected from the group consisting of chloroform, dichloromethane and 1-chlorobutane; and wherein
the amides are dimethylformamide or dimethylacetamide.

9. An optical recording medium comprising an optical layer for optical data recording according to claim 1.

10. An optical recording medium capable of recording and reproducing information with radiation of blue laser at around 405 nm, comprising an optical layer for optical data recording according to claim 1.

11. An optical layer for optical data recording according to claim 1, wherein the inorganic cations are alkaline cations or earth alkaline cations.

12. An optical layer for optical data recording according to claim 1, wherein the organic cations are selected from the group consisting of pyridinium or chinolinium or isochinolinium or ammonium (—NR₅R₆R₇R₈⁺) with R₅ to R₈ independently being selected from hydrogen, C₁₋₁₂ alkyl, C₆₋₁₂ aryl, and —NR₃R₄, with R₃ and R₄ independently being hydrogen, C₁₋₁₂ alkyl benzyl or C₆₋₁₂ aryl.
